(19) United States
(12) Patent Application Publication
(10) Pub. No.: US 2024/0062666 A1
(43) Pub. Date: Feb. 22, 2024

(54) EVALUATION ASSESSMENT TOOL AND USES THEREOF IN INDIVIDUAL SUBJECT ASSESSMENT AND REPORT GENERATION

(71) Applicant: Irma Pedraza, Pflugerville, TX (US)

(72) Inventor: Irma Pedraza, Pflugerville, TX (US)

(21) Appl. No.: 18/231,125

(22) Filed: Aug. 7, 2023

Related U.S. Application Data
(60) Provisional application No. 63/399,575, filed on Aug. 19, 2022.

(51) Int. Cl. G09B 5/00

(52) U.S. Cl. CPC G09B 5/00

(57) ABSTRACT

A rapid and accurate system and method for preparing an educational assessment report is disclosed. The system and method provide for a Database Source comprising a plurality of informational and/or performance metrics (“Cluster data sets”), each having an assigned “Header” label/indicator, a merge-macro template comprising a plurality of electronically loadable fields, and a user interface. The user interface is in electronic communication with the Database Source and the merge-macro template. The system comprises an executable computer program that upon executed of an electronic communication from a user, will merge and analyze the cluster data sets and the corresponding standardized data set to provide an educational analysis and/or assessment of the subject in the form of a report. The report provides an educational assessment report that may be generated upon command in an electronic or written format, and transmitted securely to an intended recipient.

### RELATED APPLICATIONS

The present application claims priority to U.S. Provisional Patent Application No. 63/399,575, filed Aug. 19, 2022, which is specifically incorporated herein in its entirety.

### FIELD OF THE INVENTION

The present disclosure relates to the field of methods and systems for individual student/subject evaluation and assessment, such as a student at a school or institution of higher educational learning. Electronically implemented systems and methods for educational assessment of an individual student are also related to the field of the present disclosure.

### BACKGROUND OF THE INVENTION

In the world of educational assessment (including educational assessment using the standard Full Individual Evaluation (FIE), Psychological Evaluation, and the Psychoeducational Evaluation assessment programs), report writing, gathering/collecting and entering data about the subject, analyzing the data to provide an evaluation and educational assessment of the student, and generating a written report of the evaluation and educational assessment results, is a time consuming and difficult process. Inconsistencies in data gathering and reporting, as well as multiple different data collectors inputting collected data on any number of different characteristics of multiple students, introduces yet another margin of error in the evaluation process, thus possibly compromising the integrity of the accuracy of the evaluation as to the student, as well as between students. In addition, the metrics on which data is collected and compiled together in a single method and/or system, do not typically include data on a number of important individual student characteristics that may/do impact the overall educational assessment of the student and particular needs/modifications/characteristics of the student to be considered as a whole (such as language proficiencies, cultural differences, economic resources, emotional/behavioral challenges, etc.). As a result, a conventional educational written report is often times generated by educators and related professionals that does not reflect the overall needs and/or the educational proficiency level and capabilities of a particular student. In addition. conventional educational assessment tools used in the educational and the academic fields, in general, remain very time consuming. With administrative/professional staff time and resources being most times very limited, a huge back-log may remain of many students waiting for evaluations to be completed, and many students remain without an evaluation at all because of insufficient resources, among other things. Many students therefore remain underserved, and are not accommodated appropriately to achieve their true educational potential.

In traditional terms, written reports concerning educational assessments are written in a very customary, routine fashion, without consideration of factors related to cultural, language, and other diversity and non-diversity related factors that impact a subject individual's overall educational evaluation. The scores, percentiles, and descriptive ranges, which are typically the primary and essential criteria used in report writing, are used to generate a score summary. The score summary is generated either by a computer scoring program or manually by using a standard examiner's manual. Metrics are gathered on the student on a number of conventional criteria, and used in the written report. The written report may include a determined confidence interval and a Cognitive Academic Language Proficiency and proficiency level determination, as used for bilingual evaluations. The data generated for each of the criteria is typically manually entered by an administrator (for example, diagnostician, school psychologist, counselor, evaluator or team of evaluators, or other administrative professional) into tables, these tables of data also being entered into the written report. A final proofing of the written report is also done to ensure that the information entered in the tables and in the narrative text is accurate, and is consistent with the score summary report.

Even though some software and/or web-based programs facilitate and accelerate table creation for a report, the process of the actual writing of the report and report generation is not performed in a single or coordinated group of software modules. Instead, the process remains largely a manual, hands-on process that is prohibitively time-consuming. Therefore, proofing the overall report, the data, the tables, and the text narrative remains tedious, and places inordinate time demands on available administrative/professional resources. This process is also characterized by a much higher risk of error in user/input and review of data, as multiple data entry input points for recordation of criteria data exist in several sections or fields that appear in a written report. This additional risk of error reduces the overall accuracy and reliability of the score summary report.

Another consideration that could be problematic in report writing is the modifications needed to address certain eligibility areas (ADHD, OHI, emotional disturbance eligibility, etc.), the most common eligibility area being for a Specific Learning Disability.

Maintenance of the standard or traditional form of report writing, without efforts to improve the process, is perpetuated by workshops, trainings and template models that are routinely included in educational assessment publications.

The length of standard, traditional written reports, and the complexity and amount of data (collected and compiled in huge databases), contributes to the significant amount of operator/administrator time needed to prepare a written report. This in turn increases the risk of human error in data entry, inconsistencies in recorded metric data, etc. While existing tools provide at least some resource for implementing necessary data for preparing a score summary in report writing, a need remains for additional report generating tools that can expedite the accuracy and integrity of the final report writing process in a cohesive and comprehensive system.

A more time-efficient and accurate tool is needed to more quickly and accurately generate educational reports for a greater number of students, while also being less time-demanding on administrators and other educational professionals.

### SUMMARY OF THE INVENTION

The present invention provides a unique solution to the above and other deficiencies and inefficiencies in current assessment systems.

The present disclosure provides a solution to student and institutional needs, and provides for quick, efficient, and accurate data input that may be implemented in an improved and more accurate final report generating tool and/or system/method, that also is much less time consuming on the administrator and/or other educational professional. The present systems/methods also incorporate data collected on the cultural, language, socio-behavioral characteristics, and special needs of the student in a single evaluation process that merges and consolidates an expanded set of data metrics on many different student criteria in a single operation. This feature, among others, is an advantage over existing educational report generating systems and protocols.

The present methods and systems are electronically implemented so as to permit computer generation of an accurate and reliable written report, in a fraction of the time required in conventional written report generating approaches. Thus, an additional advantage of the present systems and methods is that they are much more time efficient. This permits a greater number of subjects (students) to be evaluated in a much shorter period of time and with less administrative resources.

In one aspect, the present invention provides a method and/or system for providing an accurate educational assessment and/or psychoeducational evaluation of a subject/individual. The method and/or system is formatted to provide a more rapid and accurate individualized evaluation of the student/individual, that includes a number of more robust and diverse student database data, which includes data collected about a subject on a greater number of criteria, including diversity-related criteria, and merges the all of the data in a collective (combination) of these data bases electronically, and from this analysis of merged data, generates and/or creates a student educational assessment report. The inclusion of more robust and diverse subject data into the analysis is provided by incorporating the data related to a particular metric in a database module. Each database module will include an executable program that will direct a computer, once the database module is loaded into a merger template, to perform a series of analysis/compilation relevant to the particular metric being measured and stored in the particular database module.

Each database module of the system/method is accessible to a user by storing/saving the database module on a computer database, and then incorporating the database module into an electronic merger template that may then be analyzed as part of an executable computer system. The electronic merger template will also include a database module of data/information included in conventional database modules. The method and/or system may include, as an ultimate step, the generation of an educational assessment report for a particular student/individual in electronic form or written form. The system and/or process may provide for analysis of all of the information/data inputted electronically, and thereby provides a more comprehensive, single-step educational assessment program tool. The ultimate analysis performed may then be used to generate a written report or an electronically transmittable report, of a student/individual. This process may be performed in a fraction of the time typically required for educational report preparation using customary techniques routinely used in educational institutions.

In some embodiments, the method and/or system is described as a Psychoeducational Evaluation Tool or an Educational Assessment Tool (EAT)™. In some embodiments, the method and/or system provides for the creation of an electronically executable merge-macro template that may be used to generate an educational report for a specific and/or particular subject/individual, such as a student or applicant to a public or private school or school program. The merge-macro template used in the system to generate the written report incorporates a combination of data bases that comprise a Data Source Document, the Data Source Document comprising two or more identifiable “cluster test” sets of data or “subtest” sets of data. Each “cluster set” or “subtest” set of data will be labeled with an applicable descriptive title (for example, a “cluster set” of data may comprise data points (evaluations) of an English standard oral language score, an English oral language percentile, an English oral language range, and a CALP (Cognitive-Academic Language Proficiency); an English oral language expression data set, percentile, range and CALP; a Spanish Standard oral language Score, a Spanish oral language percentile, a Spanish oral language percentile, a Spanish oral language range, and a CALP), and be titled/saved electronically with an identifiable “Header”, such as “DataSourceTestsofOralLanguage” (See FIG. 1). Sets of data may provide English language proficiency, non-English proficiency, etc. The various compiled sets of data on a single subject had not previously been tabulated and merged into a “merge-macro” template (See FIG. 2), as described in the present methods/systems.

The “merging” of databases as described herein, from several databases collected and tabulated for a particular subject, together in a single executable programmable and executable, format, had not previously been described, or implemented in the educational evaluation industry.

The unique combination of criteria created as part of the present systems and/or methods provides for a more accurate reflection of the skills, weaknesses, learning and capability levels of an individual subject. This renders the system and/or methods, and the reports generated using the system and/or methods, more accurate and of higher quality. The merge-macro template provides the administrator with a more reliable and efficient tool that is able to more accurately evaluate and/or assess a subject/individual. The unique electronically programed and executable merge-macro template incorporates data metrics that include individual cultural, language, and social characteristics, technical strengths and technical and other weaknesses. This improved tool may also be used to identify a suitable, or a more suitable, educational or training program, or level within an educational or training program, for a particular subject/individual. An educator, or institutional custodian or counselor, may use the tool as part of a method to more accurately assess and evaluate a particular subject/individual, and to place that particular subject/individual within a program best suited to meet and nurture his/her educational, emotional, psychological and other unique needs.

The advantages of the present systems and methods also includes a faster and more efficient method for processing applicant and/or student data. Thus, evaluations may be completed, in most cases, in less than half the time typically required by administrators to perform an analysis and/or report. The enhanced efficiency and lower costs, combined with lower demands on administrative and/or professional service personnel, are therefore significant additional advantages of the present overall systems and/or methods. The systems and/or methods are ideally suited to handle large numbers of students and/or other individuals at both small and large institutions/organizations. The systems and/or methods also provide for enhanced report accuracy, and a more streamlined and comprehensive approach to individual subject assessment and evaluation by inclusion of a wider range of more diverse subject specific data collection and input into the evaluation process.

In particular embodiments, the method and/or system may be described as providing a unique platform for student and/or individual assessment that includes a merge-macro template comprising a database that includes a unique combination of diverse characteristic metrics criteria. The system provides for storing and organizing collected evaluation assessment information data of the individual, and for merging this data with the merge-macro template tool, to generate a final written report, in a fraction of the time than is currently required for conventional written report assessment generating systems.

The system and/or method implemented in the evaluation assessment tool may be described as a process that enhances accuracy, shortens administrator report-generating time requirements, and that is different from other assessment tools. The present tool generates scores in tables and text narrative as components of the tool application system process. The tool takes into account outlier scores, and in this way enhances standardization among individuals when using the tool. Individual data sources incorporated as part of the present methods and systems are also programed to remove/discount outlier data. The assessment design incorporates individual characteristics such as Language Dominance for Bilingual assessment reports, and includes Cognitive and Academic reports suitable for accommodating both Bilingual or Monolingual report writing. These criteria had not previously been incorporated into individual evaluation tools, and therefore such reports had a higher degree of inaccuracy, and lacked specificity for the particular individual being evaluated. In some cases, this lack of data criteria in the process seriously impacting the relevance of the report generated, and thus did not best reflect the needs of the individual being evaluated.

The present assessment tool generates an accurate report rapidly, using a unique combination of diverse and conventional individual criteria. The unique combination of criteria includes conventional and/or standard criteria. This aids in facilitating the writing of the report, and in facilitating the easier utilization of the report as an evaluation tool by school administrators and other professionals.

The Educational Assessment Tool™ provides for enhanced efficiency, enhanced accuracy, reduced costs, more inclusive and expanded individual student metrics data metrics, and a more user friendly tool for generating an educational report product, compared to conventional educational assessment modalities and report formats.

### BRIEF DESCRIPTION OF THE DRAWINGS

FIG. 1 illustrates a database source that includes the standard scores, percentile, and descriptive range that need to be entered by the evaluator from the summary report.

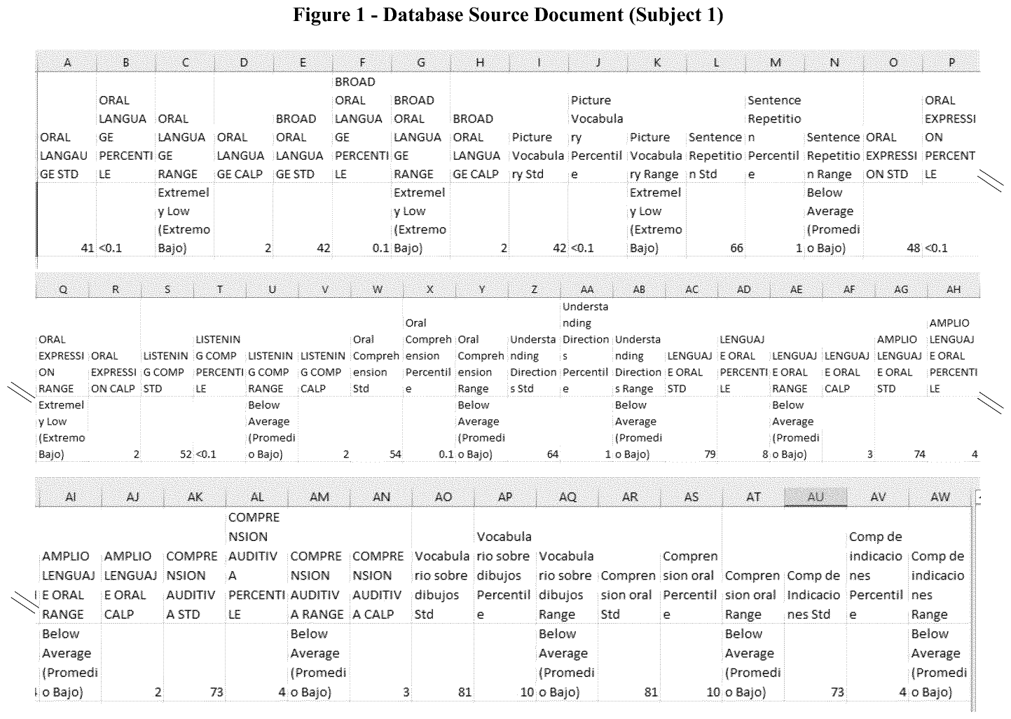

FIG. 2 illustrates the merge-macro template document.

FIG. 3 illustrates the final document once the merge process has been performed.

FIG. 4 illustrates the procedures in creating the database source document, the merge macro document and the results of the final generated report.

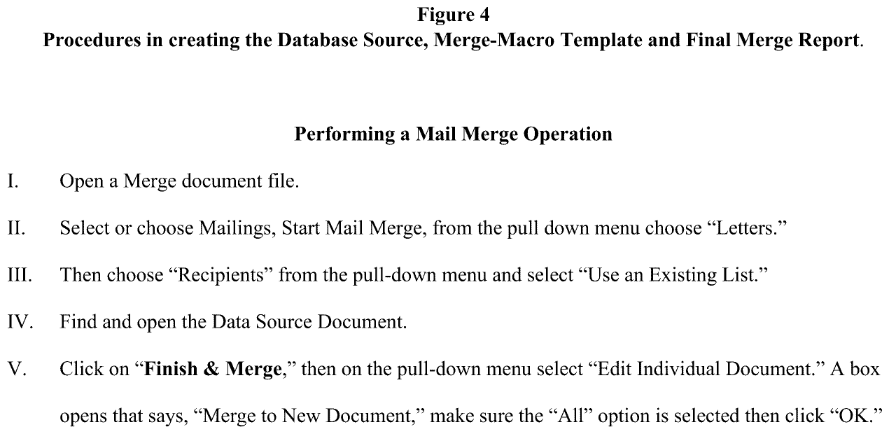

FIG. 5 illustrates the Educational Assessment Tool™ creation of subject database source, and steps for a merge macro template with performance of a merge operation to create a final generated report.

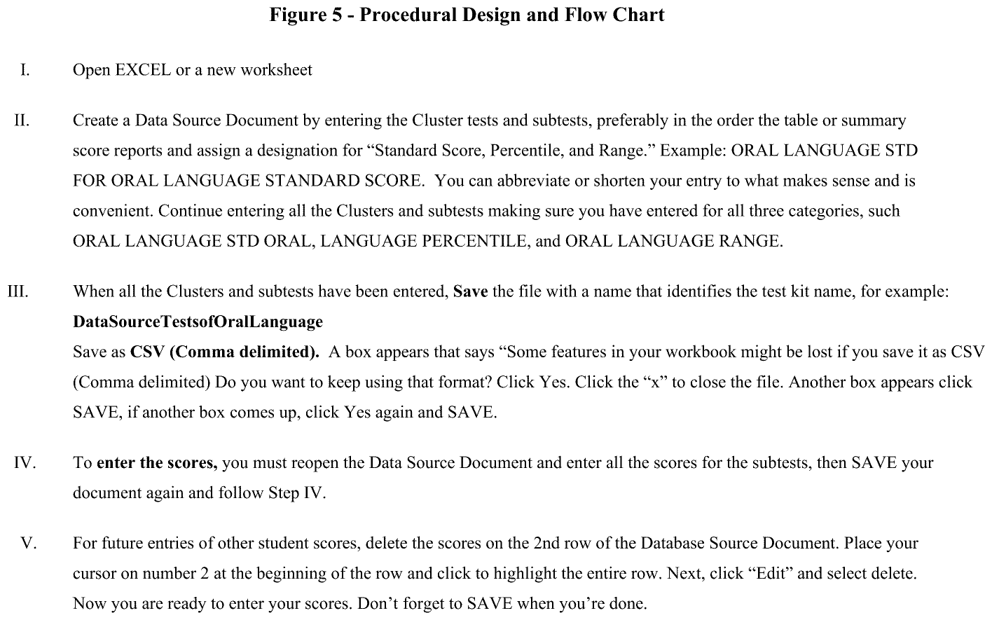

FIG. 6 illustrates a Merge Macro Template format. Note: If you have a message when you open an existing data source file, select “Enable Editing” and it may ask something like “Data from Database place in your Doc” Select “No.” This should open your merge document.

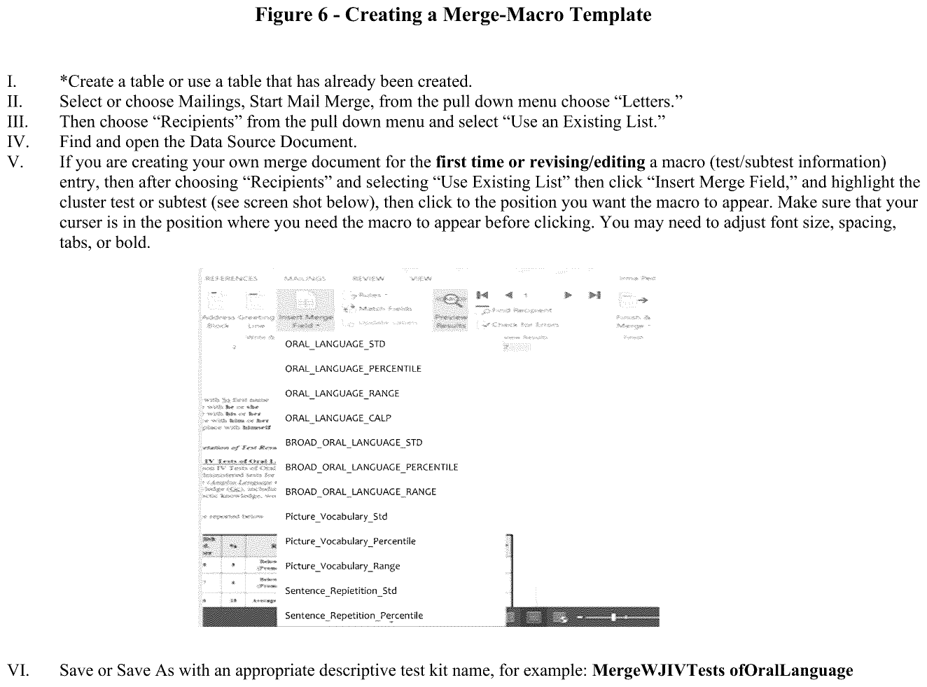

FIG. 7 illustrates a Mail Merge Operation of the EAT™ system/method.

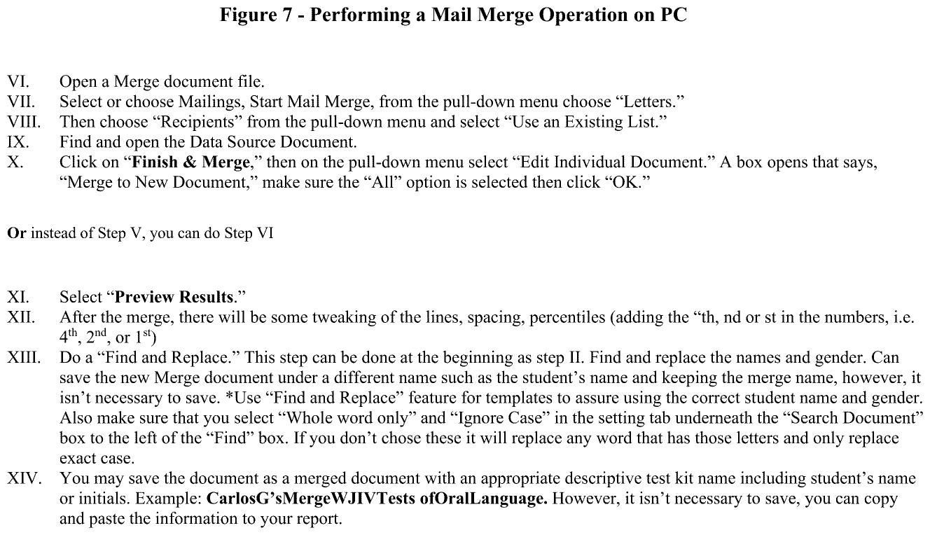

FIG. 8 illustrates a flow chart of the EAT™ system/method. It is recommended that when performing the final merge operation, that the merge operation be done in sections, for example, to complete a StudentNameMergeTestsofOralLanguage section first, then to copy and paste this completed section into a report; next, the user would complete a StudentNameMergeWJIVCognitive report, and then copy and paste this section into the report; next, to complete the StudentNameWJIVAchiev section, and then copy and paste this completed section into the report. These reports are individually referred to as “macros”. When there is a Psychoeducational template to also be used, and it is desired to merge macros already embedded in the report, performing a merge operation for these macros while also selecting a Data Source file would result in only performance of the procedure for the specified Data Source selected, for example, with the DataSourceTestsofOralLanguage report. In this instance, the program would not be able to complete the merge for the completed Cognitive and Achievement report, and sometimes, the processing of these macros in this fashion, may even cause errors.

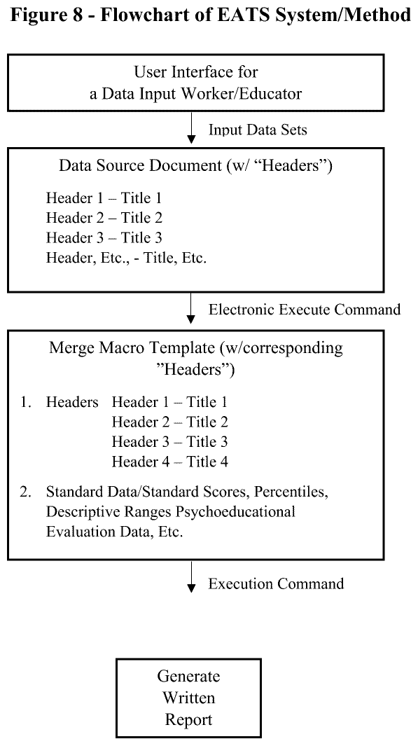

### DETAILED DESCRIPTION OF THE INVENTION

The present Evaluation Assessment Tool (EAT)™, in a general and overall sense, provides an efficient and more accurate psychoeducational assessment system that provides for more rapid report preparation and writing. The assessment process tool provides for constructing a data source document that corresponds to an analysis template (a macro template). A user may electronically instruct the tool to perform a specified series of steps for desired analysis of metrics, to generate a final report of an individual subject. The Evaluation Assessment Tool™ facilitates an easier and more time efficient manner to accomplish report writing.

The following examples present a description of various specific aspects of the intended invention, and are not presented to limit the intended invention in any way.

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

The EAT™ provides a method that comprises the steps of collecting a plurality of data scores and collecting summary report data generated from conventional scoring software and/or conventional manual scoring results, as well as other conventional educational information (for example, the Cross-Battery Analysis), to provide a cumulative database source. This information is inputted into a data source database. The data source database will include a number of headings. These headings are incorporated into the creation of a macro to provide a Merge-Macro Template. The merge-macro template will assist in guiding data entry input information. This is done when the pre-determined fields are populated in the data source document. Once this is done, then the merge document is created by inserting macros into a document table, with a final step being to perform the merge operation by selecting the “Complete Merge” option.

The efficiency enhancement lies in part in the initial inclusion of all data from all of the sources of data into the system data source document at the beginning of the process steps. This is the only relatively time-consuming step in the process. However, this initial step becomes a point of greater efficiency in generating a more inclusive overall report process. Data sources for common and conventional metric databases (normed reference databases), are used by Evaluation personnel (e.g., LSSPs (School Psychologist) or Diagnosticians) and are compiled and used as a component piece of data to avoid replication of effort and time-consuming individual data step entry. In this manner, a need for the Evaluation personnel to enter the data source field would be avoided, since the data base has in this manner has been standardized in the creation of the database source module. Data entry will therefore be limited to entry of scores for the unique individual student. Once this individual data is entered, a computer merge operation will generate the final product into the tables and body of the report. For a typical report, the administrator/evaluator has to enter scores manually into the tables and body of the report for each subject individual, which is time consuming and prone to user error in data entry and transposition of score information among different subject individuals. Once all of the data from multiple data sources has been included in a desired data source database, a final step for generating a complete psychoeducational report may be taken. The final report is generated automatically with insertion of all the scores in the tables and body of the report, and thereby expedites report writing to produce a virtually error free report. The methods/systems disclosed here save at least two or more primary data entry process steps that are required in current, conventional report writing. In more conventional report writing/generation, information is first entered in a table format and then again several times in the narrative text report. The cost-effectiveness and enhanced value of the EAT™ process and/or system is reflected in significant time savings to the academic and/or educational professional user, the savings in time in turn becoming available to devote to other pertinent professional tasks, including performing assessments, counseling, consultation, and addressing issues in more specialized student/subject cases. These increased efficiencies therefore benefit the academic institution and/or school district, with greater employee productivity.

The Educational Assessment Tool (EAT)™ comprises a comprehensive database source, a merge-macro template, an input source, and a user interface. The merge-macro template assesses a plurality of databases, which includes the Data Source Document, and a plurality of standard scores, percentiles, descriptive ranges, and other critical information data that is specific to a particular and more complete psychoeducational evaluation of a particular cohort of students and/or of a particular student. The merge-macro template will be in electronic communication with the comprehensive assessment database source. The comprehensive assessment database source will serve to store the data until such time as a step of executing an analysis and assessment step on the database is electronically transmitted/communicated to the database source from a user. Transmission of the electronic order to execute the analysis and assessment step on the data base will result in populating the data into the merge-macro template and generation of the final report. The specification created by the database source and merge-macro template may be used by assessment to generate the final report.

### Example 1—Education Assessment Measurement

The traditional procedures incorporate scores that contain critical data needed for report writing. The process entails creating tables and a narrative test that needs to be entered into the report. The Cross-Battery Assessment Software allows assessment to access analysis of cross-battery assessment findings, yet it also does not carry out the process of transferring the informational data into a generated psychoeducational report.

The Education Assessment Tool™ design process supports the complete full and individual psychoeducational report from the tool specifications. It provides the entry of criteria into databases, merges the databases into a Merge-Macro Template, and provides a final assessment through a process resulting in the generation of a final psychoeducational report.

### Example 2—Comparison Information

Examples of time requirements for report writing using (1) the Educational Assessment Tool™ and (2) Manual report writing. The results below demonstrate that report writing can be accomplished almost twice as quickly using the EAT™ compared to report writing using conventional manual report writing procedures.

Tests of Oral Language used to determine receptive and expressive results. For Bilingual reports in addition CALP and language proficiency information is included.

Test of Oral Language Monolingual report using EAT™=8 minutes
Test of Oral Language Monolingual report manual entry=14 minutes
Test of Oral Language Bilingual report using EAT™=9 minutes
Test of Oral Language Bilingual report manual entry=34 minutes
Woodcock-Johnson Tests of Cognitive Ability using EAT™=24 minutes
Woodcock-Johnson Tests of Cognitive manual entry=40 minutes
Woodcock-Johnson Tests of Achievement using EAT=14 minutes
Woodcock-Johnson Tests of Achievement manual entry=26 minutes

The results indicate in the report writing comparisons the EAT™ reports were all done in less time, almost half the time than manual entry without using the EAT™.

The EAT™ is different than any other tools or manual entrees characteristic of other educational assessment tools/programs in at least the following aspects, and therefore also provides at least the following advantages over existing technologies in the educational field:
1) The error rate is reduced. Entered data into the one Data source Document is automatic
2) Higher efficiency—completed report in almost half the time.
3) Greater accuracy—no multiple manual data input steps.
4) Greater efficiency—The merge template document having loaded standardized data and header-specific categories that correspond to data headers in the Data Source Document, increases efficiency in report generation.

### Example 3—Eat™ Specification

The primary goal of developing the Educational Assessment Tool™ was to facilitate simpler and faster report preparation and writing. This is accomplished in part with the implementation of a universal merge template data component into the system. In this way, the methods and systems of the present invention eliminate the need of entering multiple times the most common used tests metric data used in a population of students and others for assessing disabilities. These standard tests include the Woodcock-Johnson Tests of Cognitive and Achievement Abilities-Fourth Edition, Tests of Oral Language in English and Spanish, Batería Cognitiva and Aprovechamiento-Fourth Edition (Spanish Cognitive and Achievement), Wechsler Intelligence Scale for Children Fifth Edition (WISC-V), and Kaufman Assessment Battery for Children Second Edition (KABC-II).

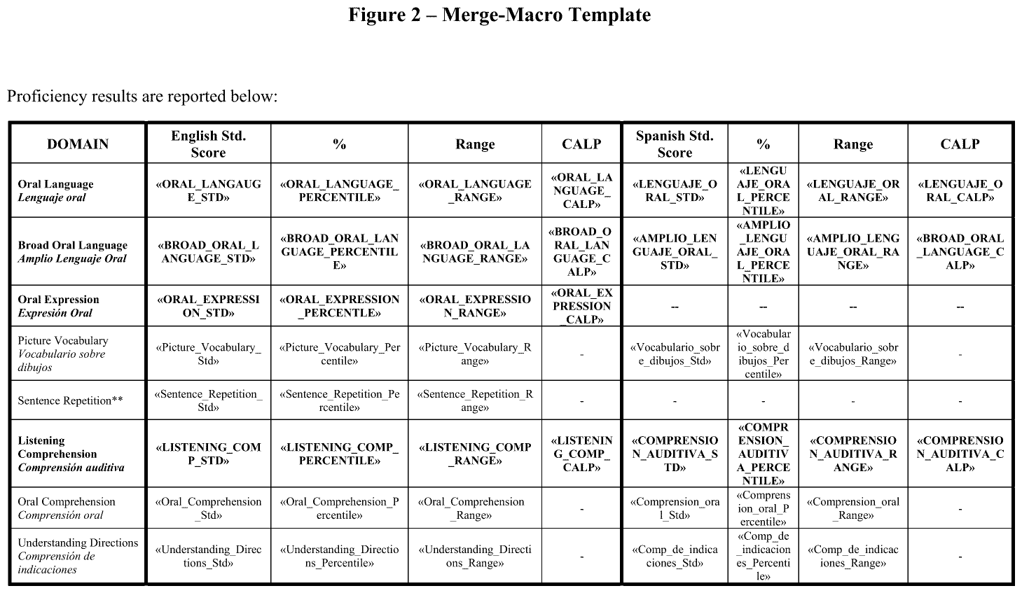

FIG. 2 provides a depiction of the Merge-Macro Template. This Merge-Macro Template will include data metrics of standardized populational testing methods, such as those identified above.

The Merge-Macro Template of the EAT™ system is not limited to the above recited standard testing metrics, and can be modified to include metrics developed for other tests. The test summary report may be computer generated or may be manually scored.

### Example 4—Case Study/Language Proficiency Metric

The present example demonstrates the application of the EAT™ with an additional metric of language proficiency/familiarity of the subject being considered in assessment of the data. This metric is not a typical metric considered in educational basement tools, and is demonstrated in this case example in a Subject 1 (an 8-year-old male Hispanic student, with English as a second language), to be useful in providing the most accurate overall educational plan for the subject individual.

Included in metric of language proficiency is the Cognitive Academic Language Proficiency (CALP) level that is generated by the test scoring program and is entered in the data source.

The CALP results provide a language proficiency of the subject/individual for both English and Spanish. The administrator/examiner may use these results to determine the Language dominance of the subject/individual.

While the EAT™ has been developed to work in conjunction with other design objects or programs, it is evident that many variations, alternatives, and modifications can be utilized and constructed using the Evaluation Assessment Tool.

### Example 5—Data Source Document—Data Format

A Data Source document is a component of the present overall methods and/or systems. The Data Source document is implemented into the present systems and/or methods generally as follows:
Raw data is generated/collected.
The raw data is entered on the Database Source Document.

The Database Source Document is an Excel spreadsheet. There are columns for each of the data categories to be populated.

Columns A-AB capture the data of a student and/or individual for the following English language related characteristics; columns AC-AW capture the date of a student and/or individual for the following Spanish language related characteristics.

Listing of Data Fields:

English Language Related Characteristics:
Column A—Oral Language Standard
Column B—Oral Language Percentile
Column C—Oral Language Range
Column D—Oral Language CALP
Column E—Broad Oral Language Standard
Column F—Broad Oral Language Percentile
Column G—Broad Oral Language Range
Column H—Broad Oral Language CALP
Column I—Picture Vocabulary Standard
Column J—Picture Vocabulary Percentile
Column K—Picture Vocabulary Range
Column L—Sentence Repetition Standard
Column M—Sentence Repetition Percentile
Column N—Sentence Repetition Range
Column O—Oral Expression Standard
Column P—Oral Expression Percentile
Column Q—Oral Expression Range
Column R—Oral Expression CALP
Column S—Listening Comprehension Standard
Column T—Listening Comprehension Percentile
Column U—Listening Comprehension Range
Column V—Listening Comprehension CALP
Column W—Oral Comprehension Standard
Column X—Oral Comprehension Percentile
Column Y—Oral Comprehension Range
Column Z—Understanding Directions Standard
Column AA—Understanding Directions Percentile
Column AB—Understanding Directions Range

Spanish Language Related Characteristics:
Column AC—Lenguaje Oral Standard
Column AD—Lenguaje Oral Percentile
Column AE—Lenguaje Oral Range
Column AF—Lenguaje Oral CALP
Column AG—Amplio Lenguaje Oral Standard
Column AH—Amplio Lenguaje Oral Percentile
Column AI—Amplio Lenguaje Oral Range
Column AJ—Amplio Lenguaje Oral CALP
Column AK—Comprensión Auditiva Standard
Column AL—Comprensión Auditiva Percentile
Column AM—Comprensión Auditiva Range
Column AN—Comprensión Auditiva CALP
Column AO—Vocabulario Sobre Dibujos Standard
Column AP—Vocabulario Sobre Dibujos Percentile
Column AQ—Vocabulario Sobre Dibujos Range
Column AR—Comprensión Oral Standard
Column AS—Comprensión Oral Percentile
Column AT—Comprensión Oral Range
Column AU—Comprensión de Indicaciones Standard
Column AV—Comprensión de Indicaciones Percentile
Column AW—Comprensión de Indicaciones Range

Foreign Language Key—the following list provides an English translation of the Spanish language related characteristics listed above:
Lenguaje Oral Standard—Oral Language Standard
Lenguaje Oral Percentile—Oral Language Percentile
Lenguaje Oral Range—Oral Language Range
Lenguaje Oral CALP—Oral Language CALP
Amplio Lenguaje Oral Standard—Broad Oral Language Standard
Amplio Lenguaje Oral Percentile—Broad Oral Language Percentile
Amplio Lenguaje Oral Range—Broad Oral Language Range
Amplio Lenguaje Oral CALP—Broad Oral Language CALP
Comprensión Auditiva Standard—Listening Comprehension Standard
Comprensión Auditiva Percentile—Listening Comprehension Percentile
Comprensión Auditiva Range—Listening Comprehension Range
Comprensión Auditiva CALP—Listening Comprehension CALP
Vocabulario Sobre Dibujos Standard—Picture Vocabular Standard
Vocabulario Sobre Dibujos Percentile—Picture Vocabulary Percentile
Vocabulario Sobre Dibujos Range—Picture Vocabulary Range
Comprensión Oral Standard—Oral Comprehension Standard
Comprensión Oral Range—Oral Comprehension Range
Comprensión de Indicaciones Standard—Comprehending Directions Standard
Comprensión de Indicaciones Percentile—Comprehending Directions Percentile
Comprensión de Indicaciones Range—Comprehending Directions Range

### Example 6—Merge-Macro Template

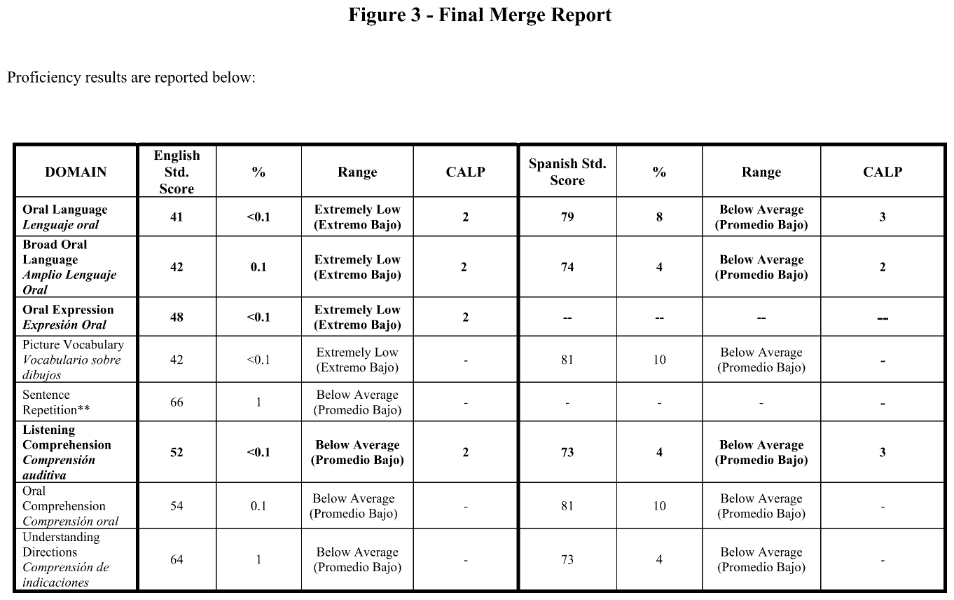

As described in Example 5, a table is created in a Word table format that contains data collected for a particular student/individual, and then stored. A merge field macro was created for each of the data fields contained in the Database Source Document in a Merge-Macro Template. Each stored table of data may be electronically incorporated into the appropriate designated slot of the Merge-Macro Template, in Word, a merge function is performed that pulls the data from the Database Source Document and organizes and populates it according to the Merge-Macro Template. Upon execution of a series of electronic commands, a Final Merge Report (from which a final written report for the Subject may be generated) is produced (FIG. 3).

### Example 7—Subject 2

### Analysis and Interpretation of Test Results

Woodcock-Johnson IV Tests of Oral Language (WJ-IV OL)

The Woodcock-Johnson IV Tests of Oral Language, Normative Update, is a norm-referenced test of individually administered tests for measuring various aspects of oral language. The Broad Oral Language (Amplio Lenguaje Oral) cluster is an aggregate measure of comprehension-knowledge (Gc), including lexical knowledge, listening ability, and verbal comprehension, syntactic knowledge, working memory, and auditory memory span. (Mean=100; SD=15)

Proficiency results for Subject 2 are reported below:

| | English | | | | Spanish | | | |
|---|---|---|---|---|---|---|---|---|
| | Std. | | | | Std. | | | |
| DOMAIN | Score | % | Range | CALP | Score | % | Range | CALP |
| Oral Language | 66 | 1 | Extremely Low | 3 | 78 | 7 | Below Average | 3 |
| Lenguaje oral | | | (Extremo Bajo) | | | | (Promedio Bajo) | |
| Broad Oral | 61 | 1 | Extremely Low | 3 | 73 | 4 | Below Average | 3 |
| Language | | | (Extremo Bajo) | | | | (Promedio Bajo) | |
| Amplio Lenguaje | | | | | | | | |
| Oral | | | | | | | | |
| Oral Expressión | 67 | 1 | Extremely Low | 2 | — | — | — | — |
| Expresion Oral | | | (Extremo Bajo) | | | | | |
| Picture Vocabulary | 66 | 1 | Extremely Low | — | 84 | 14 | Below Average | — |
| Vocabulario sobre | | | (Extremo Bajo) | | | | (Promedio Bajo) | |
| dibujos | | | | | | | | |
| Sentence | 76 | 6 | Below Average | — | — | — | — | — |
| Repetition** | | | (Promedio Bajo) | | | | | |
| Listening | 74 | 4 | Below Average | 3 | 71 | 3 | Below Average | 3 |
| Comprehension | | | (Promedio Bajo) | | | | (Promedio Bajo) | |
| Comprensión | | | | | | | | |
| auditiva | | | | | | | | |
| Oral Comprehension | 74 | 4 | Below Average | — | 77 | 7 | Below Average | — |
| Comprensión oral | | | (Promedio Bajo) | | | | (Promedio Bajo) | |
| Understanding | 80 | 9 | Below Average | — | 70 | 2 | Below Average | — |
| Directions | | | (Promedio Bajo) | | | | (Promedio Bajo) | |
| Comprensión de | | | | | | | | |
| indicaciones | | | | | | | | |

**Does not factor into overall Broad Oral Language composite score.

The Subject was administered Woodcock-Johnson IV Tests of Oral Language (Lenguaje Oral). His oral language skills are in the Below Average (Promedio Bajo) range in Spanish. The Subject received a standard score of 78. The Oral Language results in English are in the Extremely Low (Extremo Bajo) range. The Subject earned a standard score of 66. The Broad Oral Language (Amplio Lenguaje Oral) skills are in the Below Average (Promedio Bajo) range in Spanish. The Subject received a standard score of 73. In English, his score of 61 was in the Extremely Low (Extremo Bajo) range.

When compared to same-age norms in Spanish, the Subject received a standard score of 71 in the Listening Comprehension (Comprensión Auditiva) cluster. The Subject's Listening Comprehension (Comprensión Auditiva) cluster score was in the Below Average (Promedio Bajo) range. In Spanish, Listening Comprehension is comprised of two tests: Understanding Directions (Comprensión de indicaciones) and Oral Comprehension (Comprensión Oral). Understanding Directions measures listening comprehension and memory span. Students with poor memory or limited language skills may have special difficulty with this task. The Subject scored 70, in the Below Average (Promedio Bajo) range, and it appears that the low score is due to his limited language skills. Oral Comprehension does not require reading; however, it does measure listening ability and language development. Low performance in Oral Comprehension could be due to limited semantic or syntactic knowledge or poor attention. The Subject scored 77, in the Below Average (Promedio Bajo) range.

When compared to same-age norms in English, the Subject's receptive language skills were noted to be in the Below Average (Promedio Bajo) range. The Subject received a standard score of 74. In the Understanding Directions test, the Subject scored 80, in the Below Average (Promedio Bajo) range, and it appears that the below average score is due to his limited language skills. In the Oral Comprehension test, the Subject scored 74, in the Below Average (Promedio Bajo) range. His average score indicates that the Subject has inadequate language development and syntactic knowledge in English.

The Subject's expressive language skills on the Picture Vocabulary (Vocabulario sobre dibujos) test are in the Below Average (Promedio Bajo) range in Spanish. The Subject's standard score is 84. Picture Vocabulary measures vocabulary and knowledge of culture. His expressive language skills were noted to be in the Extremely Low (Extremo Bajo) range in English. He earned a standard score of 66 in Picture Vocabulary. Low performance may be a result of limited vocabulary, limited exposure to the prevalent culture, or word retrieval problems. Vocabulary development appears to be the most impacted and usually is evident in low scores in the Picture Vocabulary test.

The Sentence Repetition test is only available and administered in English in the Oral Expression cluster. The Subject received a standard score of 76, which is in the Below Average (Promedio Bajo) range. His below average score indicates a weakness in tasks requiring word retrieval problems and meaningful memory. In English, his expressive skills were noted to be the Extremely Low (Extremo Bajo) range. He received a standard score of 67 on the Oral Expression cluster. The Subject demonstrated a weakness in both languages in expressive skills.

Comparative Language Information

The Subject's broad oral language ability in Spanish is limited. His oral language ability in English is limited when compared to the abilities of others of his age.

Comparative Language Information (Spanish compared to English) Cognitive-Academic Language Proficiency (CALP) is defined as language proficiency in academic setting. Classroom-appropriate academic proficiency is further defined by literacy skills involving conceptual-linguistic knowledge.

### Broad Oral Language: 50/38

CALP (Cognitive-Academic Language Proficiency)
Level 1=Negligible English or Spanish
Level 2=Very Limited English or Spanish
Level 3=Limited English or Spanish
Level 3-4(3.5)=Limited to Fluent
Level 4=Fluent English or Spanish
Level 4.5=Fluent to Advanced
Level 5=Advanced
Level 6=Very Advanced
Level 1, Negligible English/Spanish CALP. When compared with others of the same age or grade, an individual at level 1 demonstrates negligible cognitive academic language proficiency. If provided with English/Spanish instruction at the subject's chronological age or corresponding grade level, it is expected the subject at level 1 will find the language demands of the learning task impossible to manage.
Level 2, Very Limited English/Spanish CALP. When compared with others of the same age or grade, an individual at level 2 demonstrates limited cognitive-academic language proficiency. If provided with English/Spanish instruction at the subject's chronological age or corresponding grade level, it is expected that a subject at level 2 will find the language demands of the learning task extremely difficult.
Level 3, Limited English/Spanish CALP. When compared with others of the same age or grade, an individual at level 3 demonstrates limited cognitive-academic language proficiency. If provided with English/Spanish instruction at the subject's chronological age or corresponding grade level, it is expected that a subject at level 3 will find the language demands of the learning task very difficult.
Level 4, Fluent English/Spanish CALP. When compared with others of the same age or grade, an individual at level 4 demonstrates fluent cognitive-academic language proficiency. If provided with English/Spanish instruction at the subject's chronological age or corresponding grade level, it is expected that a subject at level 4 will find the language demands of the learning task manageable.

Results and Interpretations

| Area | Results |
|---|---|
| Dominant receptive language | English |
| Dominant expressive language | English |
| Student's best method of communication | Oral Communication |
| Based on this information, the remainder | English - no |
| of the assessment will be conducted in the | interpreter was used |
| following language/mode of communication | |

| Area | Results |
|---|---|
| Dominant receptive language | Spanish |
| Dominant expressive language | Spanish |
| Student's best method of communication | Oral Communication |
| Based on this information, the remainder | Spanish - no |
| of the assessment will be conducted in the | interpreter was used |
| following language/mode of communication | |

| Area | Results |
|---|---|
| Dominant receptive language | Unclear |
| Dominant expressive language | Unclear |
| Student's best method of communication | Oral Communication |
| Based on this information, the remainder | English & Spanish - |
| of the assessment will be conducted in the | no interpreter was |
| following language/mode of communication | used |

Based upon the above assessment results, if it was determined that the Subject's dominant language is English in both the expressive and receptive domains, then the remainder of the examination was conducted in English. Current test results are a valid estimate of current abilities.

Based upon the above assessment results, if it was determined that the Subject's dominant language is Spanish in both the expressive and receptive domains, then the remainder of the examination was conducted in Spanish. Current test results are a valid estimate of current abilities.

Based upon the above assessment results, if it was determined that the Subject's dominant language is unclear in both the expressive and receptive domains, then the remainder of the examination was conducted in both English and Spanish. Current test results are a valid estimate of current abilities.

During testing, the Subject appeared to understand all test instructions. he/she answered questions appropriately and was able to express his/her ideas adequately. Therefore, test results are felt to be a valid estimate of his/her current abilities.

Language Summary and Recommendations—Subject 2

The Subject 2 (8-year old Hispanic male student in Elementary School), comes from a Hispanic household, with the parent speaking Spanish. He self-reported that he feels more comfortable speaking in English. The Subject is enrolled in a general education English instructional setting with ESL (English as a Second Language) support or Bilingual-Dual Language Immersion/One-way or Bilingual-Dual Language/Two-Way educational program and has been enrolled within this program since Kindergarten. TELPAS assessment results indicate minimal development of the Subject's English language skills, which corroborate or do not corroborate with data from the WJ-IV Oral Language assessments. The Subject's scores on the WJ-IV Tests of Oral Language are lower than the most recent Texas English Language Proficiency Assessment System (TELPAS) Scores.

The Subject's academic language assessment reveals that he displays overall Limited English and Extremely Limited Spanish oral language skills. His academic oral language testing revealed English dominant oral language skills results in the Below Average range. The Subject's receptive skills were higher than his expressive skills in English. His Spanish results were in the lower extreme range, which are considered to be significantly delayed. The Subject's receptive skills were slightly higher than his expressive skills in Spanish. Overall, his receptive and expressive skills were higher in English than in Spanish. The Subject should continue in his current instructional setting where he can continue to receive English as language of instruction with ESL support or Bilingual-Dual Language Immersion/One-Way or Bilingual-Dual Language/Two-Way educational program.

An English/Spanish assessment of the Subject's cognitive abilities was considered most appropriate, as he demonstrated English/Spanish dominance, and an English/Spanish assessment of his academic skills was conducted in order to gather a broad measure of his reading, writing, and mathematic skills in English. The Subject is currently in an English educational program supported by an English as language of instruction with ESL support services or by a Bilingual-Dual Language Immersion/One-Way or Bilingual-Dual Language/Two-Way educational program and the recommended mode of assessment based on his language profile would be to give him a verbal or a low/reduced verbal assessment, which will more likely be the most accurate estimate of the Subject's true abilities. A secondary or optional mode of assessment that may provide additional valuable information, but which will likely result in an underestimate of the Subject's ability, is to use an assessment in his native language.

There appears to be areas of significant relative weakness. Low performance in Oral Language may be a function of limited vocabulary, limited comprehension, poor expressive language, limited semantic or syntactic knowledge, limited exposure to the prevalent culture, word retrieval difficulties, or poor attention skills. Vocabulary development appears to be the most impacted and usually is evident in low scores in the Picture Vocabulary test, when a student, such as the Subject, has been instructed in English only without formal Bilingual instruction in his native language.

### REFERENCES

The following articles and information sources are hereby specifically incorporated herein by reference.
Cortés, J. F., & Watkins, M. W. (2017) Wechsler Intelligence Scale for Children Fifth Edition Spanish. Bloomington, MN: Pearson.
Flanagan, Dawn P., Ortiz, Samuel O. & Alonzo, Vincent C., (2013). The Essentials of Cross-Battery Assessment Third Edition, Hoboken, New Jersey: John Wiley & Sons, Inc.
Mather, N. & Wendling, B. J. (2014) Woodcock-Johnson IV Tests of Oral Language. Itasca, IL: Riverside.
Microsoft Excel. Office 365. Jul. 10, 2017, Microsoft, Redmond, Washington
Microsoft Word. Office 365. Jul. 10, 2017, Microsoft, Redmond, Washington
Singer, J. K., Lichtenberger, E. O., Kaufman, J. C., Kaufman, A. S., & Kaufman, N. L. (2012). The Kaufman Assessment Battery for Children—Second Edition. Boston, MA: Springer.
Woodcock, R. W., Alvarado, C. A., Schrank, F., Mather, N., Wendling, B. J., Ana F. Muñoz-Sandoval, A. F. (2019) The Bateria IV Woodcock-Muñoz Pruebas de habilidades Cognitivas. Itasca, IL: Riverside.
Woodcock, R. W., Alvarado, C. A., Schrank, F., Mather, N., Wendling, B. J., Ana F. Muñoz-Sandoval, A. F. (2019) The Bateria IV Woodcock-Muñoz Pruebas de Aprovechamiento. Itasca, IL: Riverside.
Woodcock, R. W., McGrew, K., & Mather, N. (2014) The Woodcock-Johnson Tests of Achievement: Fourth Edition. Itasca, IL: Riverside.
Woodcock, R. W., McGrew, K., & Mather, N. (2014) The Woodcock-Johnson Tests of Cognitive Abilities: Fourth Edition. Itasca, IL: Riverside.

What is claimed is:

1. A system for generating an educational assessment report for a subject/individual comprising:
A user interface;
a database source comprising a plurality of cluster data sets, each cluster data set comprising informational and/or performance metrics of interest of the subject, wherein each cluster data set is identified/labeled with a header indicator label; and
a merge-macro template, said merge-macro template comprising a program of electronically executable instructions, a plurality of electronically fillable database fields, and a plurality of standardized data sets of subject/individual metrics of interest of a cohort of individuals, each electronically fillable database field and each standardized data set being identified with a header indicator label corresponding to a metric of interest,
wherein the merge-macro template comprises an executable program that when executed by a user at the user interface, is capable of merging the data of the cluster data sets with the corresponding data of the standardized data set and generating an educational report for the subject/individual;
wherein the user interface is in electronic communication with the database source and the merge-macro template;
wherein the merge-macro template is in electronic communication with the database source and the user interface; and
wherein incorporation of the cluster data sets into the merge-macro template and execution of electronic instruction to the merge-macro template will merge the subject's cluster data set for a metric of interest with a data set corresponding to a standardized data set of the corresponding metric of interest, and upon execution of an electronic series of instructions to the merge-macro template, will generate the educational assessment report for the subject/individual.

2. The system of claim 1 wherein each standardized data set comprises collected data from a representative cohort group, wherein the standardized data set comprise data of conventional educational standardized scores of a cohort of subjects, comprising percentile data information, descriptive ranges and phyco-educational data metrics of the cohort subjects.

3. The system of claim 1 wherein the header indicator comprises: a set of oral language standard metrics for oral language standard score header, a language percentile header, and an oral language range header.

4. The system of claim 3 wherein the oral language standard metrics are for English language, Spanish language, or both English and Spanish.

5. A method for providing an assessment report for a subject comprising:
collecting scores from the subject for a plurality of performance metrics of choice to provide a subjects metrics data set;
entering the subject's metrics data set into the database source of the system of claim 1;
executing an electronic program having a series of steps to merge the subject's metric data set with the merge macro template of claim 1 to provide a subject populated merge template data base; and
executing an electronic program transmitted to the populated merge template data base, the electronic program having a series of steps directing the generation of an assessment report of the subject.

6. The method of claim 5 wherein the header indicator comprises: a set of oral language standard metrics for oral language standard score header, a language percentile header, and an oral language range header.

7. The system of claim 6 wherein the oral language standard metrics are for English language, Spanish language, or both English and Spanish.

8. The method of claim 5 wherein the assessment report is a written report or an electronic report.

9. The method of claim 5 comprising the step of generating a written assessment report.

10. The method of claim 5 comprising the step of generating an electronic assessment report.
